(19) United States
(12) Patent Application Publication
(10) Pub. No.: US 2015/0021999 A1
(43) Pub. Date: Jan. 22, 2015

(54) GRID APPORTIONING BIMODAL POWER MODULE AND METHOD

(71) Applicant: John A. Rodriguez, Lawndale, CA (US)

(72) Inventor: John A. Rodriguez, Lawndale, CA (US)

(21) Appl. No.: 13/946,858

(22) Filed: Jul. 19, 2013

(51) Int. Cl. H02J 3/00

(52) U.S. Cl. CPC H02J 3/008
USPC 307/52

(57) ABSTRACT

A system for storage and communication of electrical power generated at local renewable energy generations sites, for subsequent communication to the local power grid is disclosed. Employing electrical energy monitors and storage, locally generated electrical power is always communicated to the local grid within threshold parameters for sale and payment. Using timing components and software, the local generated energy can also be stored and communicated to the grid during determined times of day to yield the highest payment price.

### FIELD OF THE INVENTION

The disclosed device provides the ability to increase the economic utility of renewable power collection. More particularly, the invention relates to a device which can increase the payment gained by users selling harvested power to the electric companies by methodically supplementing collected energy at certain times of the day to thereby maintaining communicated electrical power at or above a certain power output threshold.

### BACKGROUND OF THE INVENTION

Home owners and business have sought to reduce their energy bills by harnessing the available renewable energy resources around them since the age of windmills and watermills. With the rise of electricity and the electrical grid, and the ever increasing array of electrically powered devices in the home and office, most people who employ renewable sources of energy choose not to live “off-grid” and must regularly purchase electricity from power companies to fulfill their electricity needs.

Several products are commercially available to businesses and households to harness the renewable energy from sunlight, wind, rain, tides, waves and geothermal heat and employing such means of power generation has become pervasive as fossil fuels become more expensive, and abominable for their environmental impact.

Utility companies provide households and businesses which collect renewable power with a bi-directional electric meter in replacement of their use-oriented meter. The bi-directional meter tracks the amount of electrical power generated by the renewable power site which is communicated through the meter to the local grid. Such bi-directional meters also record and displays the net difference between the generated electrical power communicated to the grid, and purchased electricity from the power company used at the site of the meter. The net power difference is recorded monthly, and users are paid for power communicated from their site if it exceeds power used from the grid. Conversely, users are charged if their power generated is less than the power used from the grid. However, even if the site generates less power than is used, the generated power communicated to the grid through the bi-directional meter, still reduces the bill to the household or business by the amount paid for the electrical power communicated to the grid. In many states, such renewable power is paid for by utilities, by law, at a higher rate than conventional power plant generated power, so it is good for the user at such renewable power generation sites, to maximize the amount of electrical power generated and communicated to the grid because the rate paid by the power company for the renewable power generally exceeds the rate charged by the power company for their own grid power.

An electrotechnical induction meter operates by counting the revolutions of a non-magnetic, but electrically conductive, metal disc which is made to rotate at a speed proportional to the power passing through the meter. Power consumption is then calculated by the following formula, where P=power (joules/s=Watts), R=disk rotations and t=period time in seconds of one revolution:

P=3600 R/t

Electrical power meters digitize measured voltage and current inputs, that are fed through a digital signal processor to calculate such parameters as instantaneous and maximum rate of usage demands, voltages, and power factors.

These metering devices allow many power companies to employ Time of Use or Time of Day metering and to thus charge a higher rate and more money for grid electricity used during peak hours and times of the year.

While such electrotechnical induction power meters record power transfer continuously, such electrical power meters record discrete power measurements taken at defined increments. Consequently, such electrical power metering devices only measure power transfer above a set minimum threshold. As such, the actual net electrical power transfer of harvested energy to the grid, may not be fully recorded during fluctuations in renewable power generation at the site over certain periods and power ranges. This reduces the payment to the user with a renewable energy generation site from the reaped energy. Further, because such renewable power in many instances must be paid for by the utility or power company at law-mandated premium rates, it is in the power company's interest to minimize the amount of electrical power purchased from such renewable energy generations sites.

Power photovoltaic modules per US Pat. Nos US 20120287687 A1, EP 1166430 B1, and WO 2003088728 A1 are used to transmit the harvested power between the house or workplace and the grid's power meter. In a typical power photovoltaic module, collected DC power from various solar radiation sources is compounded in a combiner box, runs to a charge controller, and is converted to AC current by an inverter. A main panel such as a bus, then distributes the power to run connected electrical devices or through a power meter to feed power into the grid.

However the prior art does not address the sometimes arbitrary power meter measurement, thresholds, which may be set by the power company providing the bi-directional meter, and which is required to purchase the renewable energy at premium prices over those charged for conventional grid power. As a result of these thresholds in voltage or other measured power levels, any renewable electrical power transmitted back onto the grid at a site, which is communicated below the set recordable threshold, is not purchased by the power company. Thus, the power generated below the threshold levels and communicated to the bi-directional meter at the lower level, yields no payment to the site owner, nor bill reduction as a credit against used grid-power. Thus the home or business owner who has invested to build the local renewable energy generation means such as a windmill or solar cell banks, does not sell all of the power so generated due to the bi-directional meter determined thresholds for such power.

As such, there is a need for a power module having a power load switch which is configured to either temporarily divert any collected power which is measured or sensed as being below the meter's measurement threshold, to a means for electrical power storage such as a battery, and only transmit measurable power above the set threshold through the bidirectional meter to the grid. Alternatively, such a device and method will also transmit renewable power from a site to the grid at the most economical times of the day to do so. Further, such a device and method should also provide a manner to augment the power communicated to the bidirectional meter, from earlier stored electrical energy, to raise the communicated power to the bidirectional meter to a level equaling or exceeding the threshold level for purchase and payment.

One or a combination of several power storage methods such as batteries, slow discharge capacitors or pumped water into water tanks, could be implemented for such energy storage. Employing this reservoir of unpurchased renewable electrical energy, one or a combination of switches or electrical circuits can be implemented to perform the power allocation and communication tasks of the power load switches at or above the threshold for payment.

In this respect, before explaining at least one embodiment of the apportioning bimodal power module device and method herein in detail, it is to be understood that the invention is not limited in its application to the details of construction and to the arrangement of the components set forth in the following description or illustrated in the drawings nor the steps outlined in the specification. The disclosed threshold power module is capable of other embodiments and of being practiced and carried out in various ways as those skilled in the art will readily ascertain once educated in the novel device and method of this application.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes of the grid apportioning bimodal power module device and method disclosed herein. It is important, therefore, that the claims be regarded as including such equivalent construction insofar as they do not depart from the spirit and scope of the present invention.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

The device herein disclosed and described provides a solution to the shortcomings in prior art and achieves the above noted goals through the provision of a method for storing and delivering renewable electrical energy at times and above threshold levels to insure payment, thereby increasing the amount of collected power which can be sold to electric companies for profit.

### SUMMARY OF THE INVENTION

In accordance with one preferred mode of the device and method herein, collected DC power from various solar radiation and or electrical generation sources is compounded in a combiner box and communicated to a charge controller. From the charge controller the electrical power is communicated to an inverter which converts the DC energy to AC electrical energy.

Converted to conventional AC electrical energy the power is communicated over wires to a main panel which is configured to distribute the electrical power to power connected electrical devices, or to communicate to the load switches. Some or all of the electrical power communicated to the load switches which is detected to be at a level below or above a predetermined threshold, is diverted and communicated to batteries. Electrical power determined to meet threshold requirements, is communicated through the meter to the electrical power grid. Once sufficiently charged, at times when no power is being locally generated by solar cells, windmills, or other renewable power generation means, the load switches can also direct stored electrical power, at a level within the given threshold, from the batteries, though the meter and to the grid. Such can be done at times, maximizing payment, should the local utility be purchasing renewable power at varying rates during the day or evening.

In a secondary mode, the power switching can be programmed with the time of use or time of day metering information, if an electrical meter is installed. Employing software installed to track such timing, the system can allocate more energy to storage during the times of the day when energy companies charge, and must also pay, lower energy billing rates, and communicate the stored power to the grid during times of day where payment is maximized.

As an example of one secondary mode, if an power company sets its premium rate hours for maximum payment between 6:00 pm and 9:00 pm, the controller for load switches can be programmed to divert any excess power collected outside that time slot to the storage such as in batteries. Once the batteries are fully charged, or at 6:00 pm, the controller for the load switches using appropriate software, will be programmed to divert all stored electrical energy through the power meter and to the grid thereby maximizing payment to the local user who generates the renewable power.

Any one or a combination of safety or measurement systems such as, breakers, additional charge controllers or meters can be placed throughout the circuit to ensure that all devices are properly grounded and maintained and to relay consequential savings and efficiency parameters to the module's owner.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the present invention to increase the profitability to generating sites for renewable energy.

Another object of this invention insure power communicated through a meter to the grid is within threshold levels which will be measured by the power meter.

An additional object of this invention is to allocate harvested electrical power to storage during times of the day when payment for energy is lower, and communicate it to the grid at times of day where payment is higher.

These and other objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative of the invention herein, rather than limiting. In the drawings:

FIG. 1 shows a sample flow diagram of a conventional power communication from a renewable energy generation site, to the grid.

FIG. 2 shows a sample wire diagram of a grid apportioning bimodal power module system herein, enabling the electrical power communication method herein.

### DETAILED DESCRIPTION OF THE INVENTION

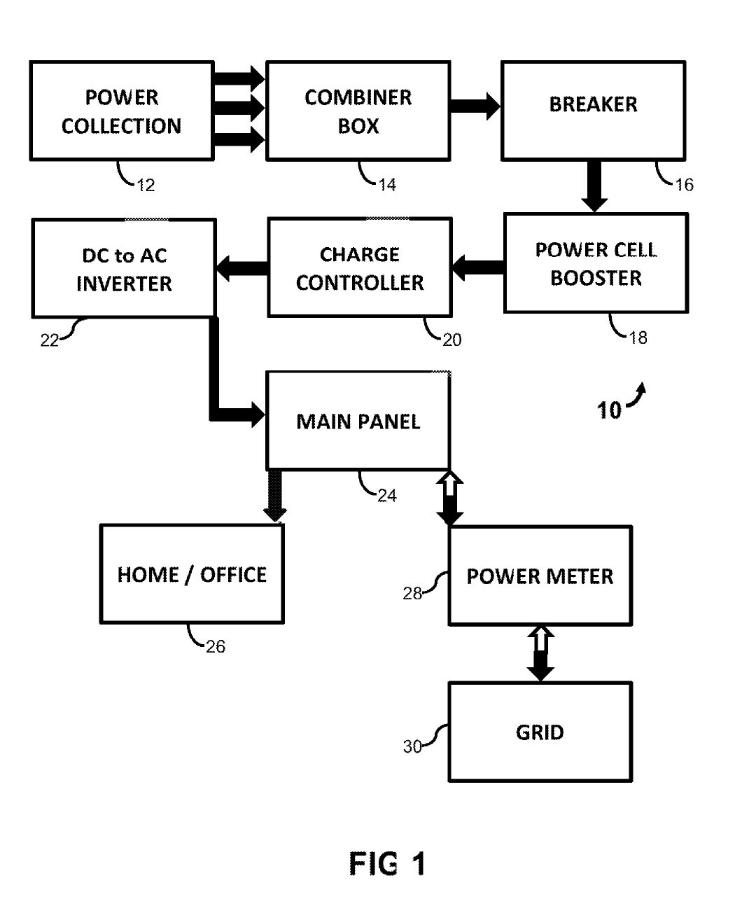

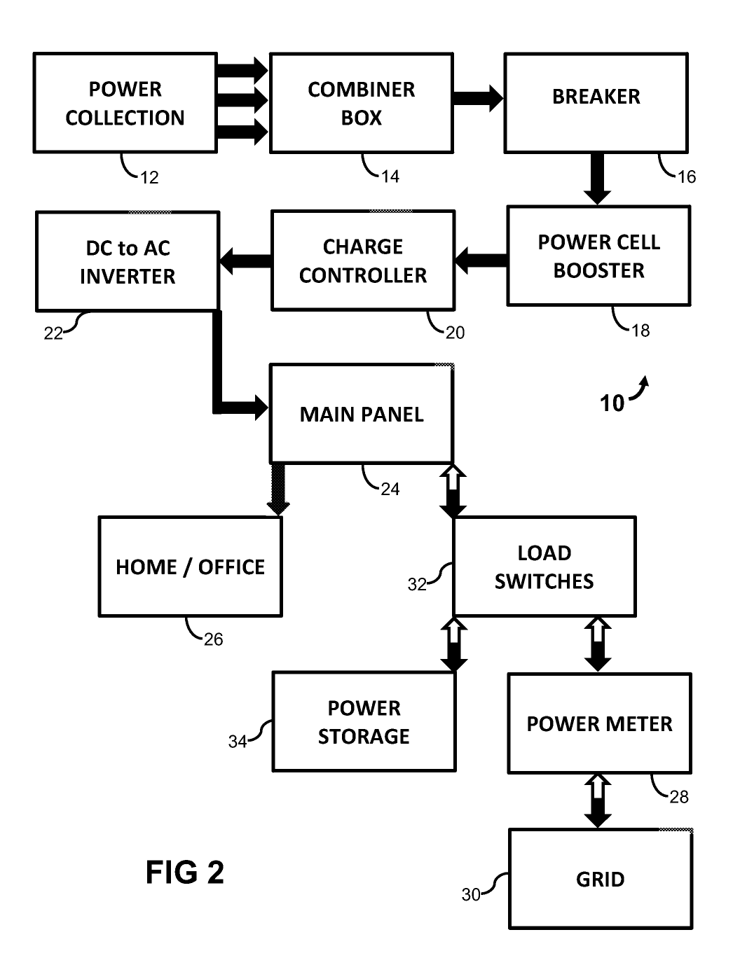

Now referring to drawings in FIGS. 1-2, wherein similar components are identified by like reference numerals, there is seen in FIG. 1, a sample wire diagram of a power module where collected DC power 12 from various multiple generation sources communicated over wiring employed for all electrical power communication herein, and compounded in a combiner box 14. The electrical power in a wired communication is communicated through a circuit breaker 16 to a power cell booster 18 and charge controller 20. From the charge controller 20 electrical power is communicated in a wired communication to be converted to AC electrical current by an inverter 22, at conventional locally employed AC voltage and cycle levels, for instance 120 volts and 60 cycles.

AC electrical power is then communicated over appropriate wiring to a main panel 24 which is configured with a buss or other electrical power communication means to distribute electrical power to provide the energy, to power connected electrical devices on circuits communicating with the main panel 24 in the home or office 26. Additionally, electrical power may be placed in a wired communication through a power meter 28, for measurement and subsequent communication to the local grid 30 at appropriate voltage and cycle levels for the grid.

FIG. 2 displays a sample wire diagram of an Apportioned Grid Bimodal Power Module where, collected DC power 12 from various solar radiation sources is compounded in a combiner box 14, runs through a breaker 16 to a power cell booster 18 charge controller 20, and is converted to AC current by an inverter 22. A main panel 24 then distributes the power to run connected electrical devices 26 or to load switches 32. A controller connected to the load switch and having a data processor running software adapted to control the switch, will control distribution of electrical power communicated to the load switches 32 at, below, or above the set power threshold level, and cause the load switch 32 to direct to AC power towards storage 34 or through the power meter 28 to the grid 30 respectively. The load switches 32 also direct any stored power above the given threshold from the batteries 32 through the power meter 28 and back to the grid 30.

In a secondary mode, the load switches 32 can be programed with the Time of Use or Time of Day metering information to increase the flow of power from load switches 32 to the grid 30 during the times of the day where energy companies' charge, and must also pay, higher energy billing rates.

As can be discerned by those skilled in the art, the system herein will work well with the disclosed components and configuration, as a method, or with operatively wired components which those skilled in the art might substitute or rearrange to maximize or achieve an increased payment for co-generation by individual remote renewable energy generations sites which sell their generated electricity to the local grid provider.

To practice the method herein, for storage and communication of electrical energy from such storage in combination with concurrently generated electricity being communicated to the grid at less than a determined threshold for payment, to communicate a combination of generated and stored electrical energy to the grid at a power level which achieves the threshold required for payment. Alternatively, the method allows for reducing communication of electricity generated by renewable means to the grid during time periods where payment for such is low, and allowing for subsequent communication thereof to the grid during time periods where payment for such is increased or maximized. The method can include one mode or the other or a combined mode where power communicated during periods of high payment for such, is communicated from storage along with co-generated power.

In either mode of the method herein, a first step will be employing wires or other conductors to communicate the DC power generated by solar cells or windmills or both, to an inverter which is configured to change the direct current electricity to alternating current electricity as well as to raise the voltage of the output alternating current (AC) to a first voltage level compatible with the local grid. Such levels would be 120 volts AC or 240 volts AC for example making accommodations for voltage variances of different systems.

From an inverter in the system, at the first voltage level of the output from the inverter, the electrical current or energy is communicated over wiring adapted to the task to a distribution panel such as a fused buss or similar electrical distribution panel which will communicate the electrical energy from the inverter directly to a load switch connected to the utility meter, or partially to the home or office if needed, and if all of the power is not being sold to the grid operator.

The load switch provides a means for interfacing the power from the inverter with the electrical power on the grid engaged to the meter. A controlled employing software running on a data processing component or device operating the controller to send switching signals to the load switch. The load switch when closed is employed at this point to communicate electrical power to the grid through the meter, and when opened by the controller will cease communication of power. Using a voltage or other electrical energy component monitor, the controller is employed to switch the load switch to close and communicate electrical power to the grid, only when the sensor monitoring and reporting to the controller, ascertains a power level which is predetermined to be acceptable by the grid operator for payment or credit. If the determined power level is found to be too low to communicate to the grid and receive payment, the controller will open the switch and reroute the electrical energy to storage in batteries either by using a rectifier to change it back to DC to charge batteries, or by other means to store the electrical energy.

In this fashion, electrical energy which would not have been paid for by the utility, as the two-way meter or other switch would not measure it or would cut off communication, due to being outside the acceptable threshold, is instead shunted to stored and communicated subsequently, and not wasted.

Alternatively, when the electrical monitoring means for electrical energy being communicated to the meter and out to the grid, reports a current or voltage level slightly under the threshold, the controller will cause a connection with stored power in batteries to be communicated through another or the same inverter, and combined with electrical power being generated in real time, to raise the communicated electrical power above the required threshold. In this fashion the meter will record the communication since it is at or above the threshold whereas without the power augmentation, it would have ignored the communicated power or disconnected it.

In a last mode of the system or method, a timing device would be communicating with the controller and software adapted to operate the controller to open and close the switch serving as the loadswitch and cease communicating electrical power in real time, when it is discerned by software and/or storage sensors for batteries and the like, that electrical energy storage exists, and, that the time of day discerned by the timing device, communicated to the software running the controller, is a time period of lower payment price from the grid operator for the communicated electricity than a subsequent time period. Thereafter, the electricity stored during the lower priced time period, is communicated through the load switch to the grid for payment at higher prices.

As can be seen, employing the proper stitching, inverting, electricity storage, and software operated controller, the electrical power generated locally, can be communicated to the local grid, in a manner which will yield the most payment to the site owner or operator, and will eliminate periods where such electrical power is generated, but not purchased due to being communicated at a level outside a threshold.

As noted above, while the present invention has been described herein with reference to particular embodiments thereof and steps in the method of production, a latitude of modifications, various changes and substitutions are intended in the foregoing disclosures, it will be appreciated that in some instance some features or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A method for storage and communication of electrical power generated at renewable energy generations sites, to the electrical power grid comprising the steps of:
communicating DC electrical energy from a local means for electrical energy generation, in a wired communication to an inverter;
employing said inverter to transform said DC electrical energy to AC electrical energy at a first voltage level;
communicating said AC electrical in a wired communication to an electrical distribution panel having a buss;
communicating said AC electrical power from said buss through a load switch;
employing software running on a computing component of a controller for said load switch, to cause a switching of said load switch form a wired communication of said AC electrical power from said buss, with one or both of a means for electrical power storage, or, an AC power meter for taking a measurement of an amount said AC electrical power which is communicated thereto within a threshold power level range, for an operative communication thereof to a local electrical grid;
employing said software on said computing component to measure said power level range, of said AC electrical power communicated to said load switch;
employing said software on said computing component to cause said load switch to interrupt said wired communication of said AC electrical power to said AC power meter during interruption time periods when said power levels are outside said threshold power level range for said AC power meter to take said measurement; and
employing said software on said computing component to cause said load switch to connect said wired communication of said AC electrical power, to said means for electrical power storage, during said interruption time periods, whereby said AC power is stored on said means for electrical power storage during said interruption times, and made available for a subsequent communication to said AC power meter within said threshold power level range.

2. The method of claim 1, additionally comprising:
employing said software running on said controller to measure said power level range, of said AC electrical power communicated to said load switch during said interruption time periods and determine if said AC electrical power is below a low point of said threshold power level range; and
if said AC electrical power is below said low point of said threshold power level range, employing said software running on said controller to cause a communication of said electrical power stored on said means for electrical power storage, to said inverter during said interruption time periods, whereby said interruption time periods are minimized.

3. The method of claim 1, additionally comprising;
determining if a provider of power to said grid has a premium time period during a day, during which a higher price is paid for said AC electrical power communicated through said electrical power meter to said grid;
during time periods of said day, outside said premium time period, employing said software on said computing component to cause said load switch to connect said wired communication of said AC electrical power, to said means for electrical power storage, whereby all or a portion of said AC power is stored on said means for electrical power storage during said time periods outside said premium time period; and
employing said software running on said controller to cause a communication of said electrical power stored on said means for electrical power storage, to said inverter during said premium time period, whereby communication of said AC power to said grid is maximized during said premium time period.

4. The method of claim 2, additionally comprising;
determining if a provider of power to said grid has a premium time period during a day, during which a higher price is paid for said AC electrical power communicated through said electrical power meter to said grid;
during time periods of said day, outside said premium time period, employing said software on said computing component to cause said load switch to connect said wired communication of said AC electrical power, to said means for electrical power storage, whereby all or a portion of said AC power is stored on said means for electrical power storage during said time periods outside said premium time period; and
employing said software running on said controller to cause a communication of said electrical power stored on said means for electrical power storage, to said inverter during said premium time period, whereby communication of said AC power to said grid is maximized during said premium time period.
